(19) United States
(12) Patent Application Publication
(10) Pub. No.: US 2010/0119876 A1
(43) Pub. Date: May 13, 2010

(54) Magnetic recording medium and method of manufacturing the same

(75) Inventor: Shinji Uchida, Matsumoto city (JP)

Correspondence Address: RABIN & Berdo, PC, 1101 14TH STREET, NW, SUITE 500, WASHINGTON, DC, 20005, US

(73) Assignee: Fuji Electric Device Technology Co., Ltd., Tokyo (JP)

(21) Appl. No.: 12/591,094

(22) Filed: Nov. 6, 2009

(30) Foreign Application Priority Data
Nov. 7, 2008 (JP) PA 2008-286522

(51) Int. Cl. G11B 5/66; G11B 5/84

(52) U.S. Cl. 428/827; 427/131; 427/130

(57) ABSTRACT

A magnetic recording medium includes a substrate, and a soft magnetic layer, a crystal orientation control layer, a magnetic recording layer, and a protective layer formed sequentially on the substrate. The magnetic recording layer includes at least one granular magnetic layer having a granular structure and a non-granular magnetic layer having a non-granular structure. The at least one granular magnetic layers includes a plurality of magnetic portions and a separation portion surrounding the magnetic portions. The separation portion has magnetic characteristics different from the magnetic characteristics of the magnetic portions. The non-granular magnetic layer is a continuous film.

### CROSS-REFERENCE TO RELATED APPLICATION

This application is based on, and claims priority to, Japanese Patent Application No. 2008-286522, filed on Nov. 7, 2008, contents of which are incorporated herein by reference.

### BACKGROUND OF THE INVENTION

1. Field of the Invention

This invention relates to a magnetic recording medium and a method of manufacturing a magnetic recording medium, and more specifically, relates to a perpendicular magnetic recording medium and a method of manufacturing the same. The magnetic recording medium of this invention is preferably a discrete track medium or a patterned medium, having good electromagnetic conversion characteristics even at high recording densities. Also, a method of manufacturing a magnetic recording medium of this invention provides excellent productivity.

2. Description of the Related Art

Magnetic recording devices are one type of information recording device which has supported the development of an advanced information society in recent years. As volumes of information increase, further improvements in the recording densities of magnetic recording media used in such magnetic recording devices are sought. In order to realize high recording densities, the units of magnetization reversal (recording units) must be made smaller. To this end, it is important that the sizes of magnetic crystal grains be reduced, and at the same time that magnetic interactions between adjacent recording units be decreased by clearly separating and demarcating recording units.

As one technique for realizing high densities in magnetic recording, perpendicular magnetic recording media have been proposed to replace longitudinal magnetic recording media. Perpendicular magnetic recording media generally have, deposited in order on a substrate, a soft magnetic layer, a crystal orientation control layer, a magnetic recording layer, and a protective layer. As the material for the magnetic recording layer of perpendicular magnetic recording media, at present CoCr system alloy crystalline films, having the hexagonal close-packed (hcp) structure, are mainly being studied. When performing perpendicular magnetic recording, the crystal orientation of the material having the hcp structure is controlled such that the c axis is perpendicular to the plane of the film (that is, such that the c plane is parallel to the film plane). In order to accommodate further increases in recording density of magnetic recording media, efforts are being made to reduce the sizes of the crystal grains forming the CoCr system alloy crystalline film, decrease the particle diameter distribution, reduce magnetic interactions between particles, and similar.

As one method of controlling the magnetic layer structure in order to raise recording densities, a method has been proposed in which a magnetic layer (generally called a granular magnetic layer) is used that has a structure in which magnetic crystal grains are surrounded by a nonmagnetic metal material such as oxides or nitrides. For example, it has been reported that by performing RF sputtering film deposition using a CoNiPt target to which SiO₂ or another oxide has been added, a granular magnetic layer can be formed having a structure in which individual magnetic crystal grains are surrounded by nonmagnetic oxides and separated, and that noise reduction is achieved (see U.S. Pat. No. 5,679,473). In such a granular magnetic layer, the grain boundary phase of a nonmagnetic nonmetal (nonmagnetic oxide) physically separates magnetic crystal grains, reducing the magnetic interaction between magnetic crystal grains. This reduction in magnetic interaction suppresses the formation of zigzag domain walls occurring in transition regions of recording units, to achieve low-noise characteristics.

As the recording layer of perpendicular magnetic recording media, use of a granular magnetic layer has been proposed. As the underlayer of the magnetic recording layer, it has been proposed that a crystal orientation control layer, having the same hcp structure as the ferromagnetic crystal grains of the magnetic recording layer, can be used (see Japanese Patent Application Laid-open No. 2003-123239 and Japanese Patent Application Laid-open No. 2003-242623). Here, magnetic crystal grains in the magnetic recording layer grow corresponding to the positions and structures of crystalline material (crystal grains) in the crystal orientation control layer. Also, nonmagnetic oxides (nonmagnetic nonmetals) in the magnetic recording layer segregate and grow corresponding to the positions of polycrystalline regions or amorphous regions in crystal grain boundaries in the crystal orientation control layer. That is, magnetic crystal grains in the magnetic recording layer above crystal grains in the crystal orientation control layer can be made to grow epitaxially, and can be made to take over the crystal orientation of the crystal orientation control layer in the magnetic recording layer, to control the crystal orientation in the magnetic recording layer. At the same time, crystal grain boundaries of an amorphous phase (nonmagnetic nonmetals) can be formed intervening on the periphery of magnetic crystal grains in the magnetic recording layer. From the above, it is possible to control the crystalline state of a granular magnetic layer used as a magnetic recording layer. In general, a perpendicular magnetic recording medium is proposed which has Ru as an underlayer and a CoPtCrO alloy with a granular structure as the magnetic layer. As the film thickness of the Ru layer serving as the underlayer is increased, the c-axis orientation of the granular magnetic layer improves, and as a result perpendicular magnetic recording media having excellent magnetic characteristics and electromagnetic conversion characteristics are obtained.

Also, perpendicular magnetic recording media have been proposed having a magnetic recording layer comprising a plurality of magnetic layers including a granular magnetic layer. For example, by forming the magnetic recording layer of a perpendicular magnetic recording medium using a granular-structure first magnetic layer and a non-granular-structure second magnetic layer, satisfactory electromagnetic conversion characteristics as well as high durability can be secured (see Japanese Patent Application Laid-open No. 2007-103008). Further, use of a magnetic recording layer has been proposed having a layer configuration comprising a first magnetic layer, a coupling layer, and a second magnetic layer, with the first magnetic layer and second magnetic layer ferromagnetically coupled, and moreover at least one among the first magnetic layer and second magnetic layer having a granular structure, so that the ease of recording of perpendicular magnetic recording media can be improved without detracting from thermal stability (see Japanese Patent Application Laid-open No. 2006-48900).

Comparatively good magnetic characteristics and electromagnetic conversion characteristics are obtained from perpendicular magnetic recording media of the prior art such as that described above employing a granular magnetic layer. However, granular magnetic layers used in perpendicular magnetic recording media of the prior art have been continuous films (also called full-coverage films) having a uniform structure overall. In order to further raise recording densities, the following must be achieved: (1) prevention of write bleeding into adjacent tracks; (2) reduction of the formation of zigzag domain walls through random placement of magnetic crystal grains; (3) reduction of the effect of thermal fluctuations due to smaller sizes of crystal grains; and, (4) reduction of magnetic interaction between magnetic crystal grains.

As means of achieving the above goals, it has been proposed that the units of magnetization reversal (recording units) be clearly demarcated. As one such means, discrete track media have been proposed. In discrete track media, a plurality of magnetic strips, which are completely magnetically separated, are fabricated, and the magnetic strips are used as tracks to perform magnetic recording. That is, boundaries between adjacent tracks are formed artificially. Discrete track media are effective for the above-described (1) prevention of write bleeding into adjacent tracks and (2) reduction of the formation of zigzag domain walls through random placement of magnetic crystal grains.

As other means to clearly demarcate recording units, patterned media are attracting attention. Patterned media are an ultimate form of recording media in which a plurality of islands forming single magnetic domains, having artificially arranged shapes and sizes, are arranged in an array, with each island recorded as one recording unit (bit).

Various methods have been proposed to obtain such discrete track media and patterned media. For example, it has been proposed that by providing gap portions in the high-permeability layer and magnetic layer in magnetic recording media having a high-permeability layer and magnetic layer on a substrate, gaps can be formed between tracks on which recording and reproduction are performed (see Japanese Patent Application Laid-open No. 4-310621, and in particular FIG. 1). By adopting such a structure, it is stated that intermixing of recorded data across adjacent tracks during reproduction can be reliably avoided.

Further, a method has been proposed in which, by etching the disk-shape substrate surface prior to forming the constituent layers comprised by the magnetic recording layer, a spiral-shape depressed portion is formed, and by filling this depressed portion with a magnetic material, magnetic strips are fabricated (see Japanese Patent Application Laid-open No. 56-119934, and in particular FIG. 1).

Further, a method has been proposed in which, by removing a portion of a soft magnetic layer, filling the areas in which the soft magnetic layer has been removed with nonmagnetic guard bands, and forming a magnetic recording layer thereupon, magnetically isolated magnetic strips are fabricated (see Japanese Patent No. 2513746, and in particular FIG. 1).

Further, a method has been proposed in which, by patterning a soft magnetic layer and crystal orientation control layer, a magnetic recording layer comprising magnetically independent magnetic strips is formed (see Japanese Patent Application Laid-open No. 2003-16622, especially FIG. 2 and FIG. 3). In this method, after forming a soft magnetic layer and a crystal orientation control layer on a nonmagnetic substrate, gap depressed portions are formed, in order to induce discrete action. Then, the gap depressed portions are filled with a nonmagnetic material to form a nonmagnetic layer. Further, when forming a magnetic recording layer thereupon, magnetic strips having satisfactory magnetic characteristics are formed on the crystal orientation control layer, but a layer having satisfactory magnetic characteristics is not formed on the nonmagnetic layer. By means of this method, a plurality of magnetically independent magnetic strips are formed, and these magnetic strips are used as a plurality of discrete tracks for recording and reproduction.

Further, a method has been proposed in which a soft magnetic layer, an intermediate layer, and a magnetic recording layer are formed on a substrate, a prescribed relief pattern is formed extending from the magnetic recording layer to midway through the intermediate layer, and the magnetic recording layer is divided into numerous recording elements (see Japanese Patent Application Laid-open No. 2006-12285). The following are described as advantages of this configuration: (1) by providing a relief pattern which penetrates the magnetic recording layer, crosstalk with adjacent tracks during recording and reproduction can be prevented; and, (2) by forming the relief pattern to midway through the intermediate layer, without affecting the soft magnetic layer, worsening of recording and reproduction characteristics can be prevented.

Further, a method has been proposed in which, by forming a resist mask having a prescribed pattern of openings on a magnetic recording layer, and then performing ion implantation through the resist mask, the magnetic characteristics in the magnetic recording layer corresponding to the positions of openings are modified, to form separation portions (see Japanese Patent Application Laid-open No. 2002-288813).

And, a method of manufacturing discrete track media and patterned media has been proposed in which a mask having a prescribed pattern is provided on a magnetic recording layer, and then an activated halogen-containing gas or a reactive liquid is made to act through the mask, to render non-ferromagnetic a portion of the magnetic recording layer (see Japanese Patent Application Laid-open No. 2002-359138). And, formation of a continuous-film magnetic recording layer on a patterned magnetic recording layer formed by a method described above has also been proposed. However, there have been no studies on the use of a granular magnetic layer as the magnetic recording layer.

As explained above, many of the methods proposed to date for the manufacture of discrete track media and patterned media depend on the intentional removal of a portion of a constituent layer of the magnetic recording media. Specifically, constituent layers are used in which a portion of the magnetic layer, the substrate, the soft magnetic layer, or both the soft magnetic layer and a crystal orientation control layer, is removed.

However, when a portion of the magnetic recording layer is removed, as in the methods described in Japanese Patent Application Laid-open No. 4-310621 and Japanese Patent Application Laid-open No. 2006-12285, the magnetic recording layer itself is directed etched, so that damage to the magnetic recording layer due to etching, and/or corrosion of the magnetic recording layer due to the etching gas or remnant components of the etching liquid, occur, and there are concerns that the magnetic characteristics of the magnetic recording layer may be degraded.

Further, in the case of a method in which a spiral-shape groove is provided in the substrate and the groove is filled with a magnetic material to fabricate magnetic strips, as described in Japanese Patent Application Laid-open No. 56-119934, formation of a magnetic recording layer having satisfactory crystal orientation and perpendicular magnetic anisotropy in only the fine grooves is difficult, and satisfactory magnetic characteristics cannot be expected.

Further, in the method of soft magnetic layer removal by etching described in Japanese Patent No. 2513746, and in the method of soft magnetic layer and crystal orientation control layer removal described in Japanese Patent Application Laid-open No. 2003-16622, a flattening process is provided. This is because if there are large depressions and protrusions in the surface, the flying stability of the magnetic head is worsened. The flattening process is performed by, for example, filling depressed portions formed by removing a prescribed constituent layer with a nonmagnetic material, then polishing and flattening the surface using for example CMP (chemical-mechanical polishing) or similar. However, it is difficult to uniformly fill minute and deep depressions without gaps. Further, in the case of minute and deep gaps, depressions and protrusions in the surface after filling are larger corresponding to the depressions and protrusions prior to filling. Hence, when smoothing the surface using CMP or another method, either it is difficult to obtain a flat surface, or the amount of polishing is increased, leading to concerns that the film thickness cannot be controlled.

On the other hand, the method of forming a separation portion in which magnetic characteristics are altered by ion implantation described in Japanese Patent Application Laid-open No. 2002-288813 is not accompanied by intentional removal of a portion of a constituent layer, so that no flattening process is necessary. However, when magnetic characteristics are altered by ion implantation, the implanted ions diffuse in lateral directions according to the depth to which the ions are implanted. When ions are implanted to a depth of 10 nm or greater, ions diffuse up to a width of approximately 10 nm. Consequently, there is a limit to the feature fineness, and this method is not preferable when fabricating separation portions of size 80 nm or less which are necessary for discrete track media or patterned media.

### SUMMARY OF THE INVENTION

This invention was devised in light of the above problems, and has as an object the provision of a magnetic recording medium which can be manufactured by a simple method, with excellent productivity, without causing degradation of magnetic characteristics during manufacturing such as is seen in a proposed discrete track medium and a patterned medium.

A magnetic recording medium of this invention includes, in order, a substrate, a soft magnetic layer, a crystal orientation control layer, a magnetic recording layer, and a protective layer, and is characterized in that the magnetic recording layer includes at least one granular magnetic layer having a granular structure and a non-granular magnetic layer having a non-granular structure; the at least one granular magnetic layer includes a plurality of magnetic portions and a separation portion surrounding the magnetic portions; the separation portion has magnetic characteristics different from magnetic characteristics of the magnetic portions; and the non-granular magnetic layer is a continuous film. Here, the magnetic recording layer may comprise a granular magnetic layer and a non-granular magnetic layer. Or, the magnetic recording layer may comprise a first granular magnetic layer, a second granular magnetic layer, a coupling layer of nonmagnetic material provided between the first and second granular magnetic layers, and a non-granular magnetic layer provided on the opposite side of the second granular magnetic layer to the coupling layer.

Further, a method of manufacture of a magnetic recording medium of this invention comprises a process of depositing, in order on a substrate, a soft magnetic layer and a crystal orientation control layer; a process of depositing at least one granular magnetic layer having a granular structure; and a process of depositing, in order, a non-granular magnetic layer and a protective layer. The method of manufacture is characterized in further implementing a process of forming, on at least one granular magnetic layer, a mask having a plurality of openings; a process of exposing through the mask the granular magnetic layer to an activated halogen-containing reactive gas, to form a separation portion at a position equivalent to the opening in the granular magnetic layer, with positions other than that portion taken to be magnetic portion; and, a process of removing the mask, to form magnetic portions and separation portions.

A magnetic recording medium of this invention adopting the above configuration has excellent magnetic characteristics and electromagnetic conversion characteristics, and is compatible with higher recording densities.

Further, a method of manufacture of a magnetic recording medium of this invention does not cause degradation of magnetic characteristics at the time of manufacture, as is seen in proposed methods of manufacture of a discrete track medium and a patterned medium of the prior art. Further, a method of this invention is simple and has excellent productivity. This is because a process of forming protrusions and depressions is not comprised, so that a flattening process can itself be rendered unnecessary.

### BRIEF DESCRIPTION OF THE DRAWINGS

FIG. 1 is a cross-sectional view showing a first example of the configuration of a perpendicular magnetic recording medium of this invention;

FIG. 2 is a cross-sectional view explaining the method of manufacturing the first example of the configuration of a perpendicular magnetic recording medium of this invention;

FIG. 3 is a cross-sectional view explaining a second example of the configuration of a perpendicular magnetic recording medium of this invention;

FIG. 4 is a graph showing magnetic measured results for the Kerr effect in samples A to C fabricated in Embodiment 2; and

FIG. 5 shows a TEM photograph of a cross-section of sample C fabricated in Embodiment 2.

### DETAILED DESCRIPTION OF THE INVENTION

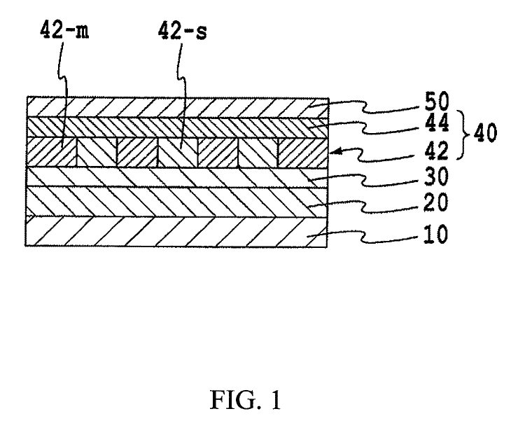

A magnetic recording medium of this invention comprises, in order, a substrate, a soft magnetic layer, a crystal orientation control layer, a magnetic recording layer, and a protective layer; the magnetic recording layer comprises at least one granular magnetic layer having a granular structure, and a non-granular magnetic layer having a non-granular structure; at least one of the granular magnetic layers comprises a plurality of magnetic portions and a separation portion surrounding the magnetic portions; the separation portion has magnetic characteristics different from the magnetic characteristics of the magnetic portions; and the non-granular magnetic layer is a continuous film. FIG. 1 shows an example of a configuration comprising one granular magnetic layer.

The magnetic recording medium of FIG. 1 comprises a nonmagnetic substrate 10, a soft magnetic layer 20, a crystal orientation control layer 30, a magnetic recording layer 40, and a protective layer 50; the magnetic recording layer 40 comprises a non-granular magnetic layer 44, and a granular magnetic layer 42, in contact with the crystal orientation control layer 30 and comprising a plurality of magnetic portions 42-m and a separation portion 42-s surrounding the magnetic portions 42-m.

The substrate 10 can be fabricated using Al alloy with NiP plating, reinforced glass, crystallized glass, or other materials normally used in the substrates of a magnetic recording medium.

The soft magnetic layer 20 is a layer provided to concentrate the magnetic flux generated by the magnetic head and to form a sharp magnetic field gradient in the magnetic recording layer 40. This soft magnetic layer 20 can be formed using an NiFe system alloy, Sendust (FeSiAl) alloy, or similar. Or, a magnetic recording medium having satisfactory electromagnetic conversion characteristics can be obtained by forming the soft magnetic layer 20 using an amorphous Co alloy, such as CoNbZr or CoTaZr. The optimum thickness of the soft magnetic layer 20 depends on the structure and characteristics of the magnetic head used in magnetic recording. However, from the standpoint of productivity, a thickness for the soft magnetic layer 20 of 10 nm or greater and 300 nm or less is desirable.

The crystal orientation control layer 30 is a layer provided to optimally control the crystal orientation, crystal grain diameters, and grain boundary segregation in the magnetic recording layer 40 (that is, the granular magnetic layer 42 and non-granular magnetic layer 44). In order to suitably control the crystal orientation in the magnetic recording layer 40, it is desirable that the surface of the crystal orientation control layer 30 on the side of the magnetic recording layer 40 comprises Ru or an alloy containing Ru, having the hcp crystal structure. Here, it is especially desirable that the Ru crystals in the Ru or alloy containing Ru be separated sufficiently to enable individual and separated growth, without connection of crystal grains in the material of the magnetic recording layer growing thereupon with adjacent crystal grains.

When Ru or an alloy containing Ru is used to form the crystal orientation control layer 30, the Ru crystals grow with grain boundaries. That is, numerous Ru crystals grow perpendicularly, i.e. from the soft magnetic layer 20 toward the magnetic recording layer 40. The Ru crystals become gradually narrower in width from the soft magnetic layer toward the magnetic recording layer, and the intervals between adjacent Ru crystals gradually broaden.

When the magnetic recording layer 40 (granular magnetic layer 42 or non-granular magnetic layer 44 comprised therein) is formed on this crystal orientation control layer 30, the magnetic crystal grains each grow above Ru crystals. When the crystal orientation control layer 30 has an appropriate thickness, numerous Ru crystals are formed at appropriate intervals on the surface of the crystal orientation control layer 30 on the side of the magnetic recording layer 40. When an appropriate magnetic material is deposited on the crystal orientation control layer 30 configured in this way, magnetic crystal grains with c-axis alignment are formed on the Ru crystals, and nonmagnetic grain boundaries of oxides or nitrides are formed so as to surround these magnetic crystal grains, to form a granular magnetic layer 42 having a granular structure.

If the crystal orientation control layer 30 is thinner than an appropriate thickness, the intervals between adjacent Ru crystals are narrower at the face of the crystal orientation control layer 30 on the side of the magnetic recording layer 40, so that adjacent magnetic crystal grains formed above the Ru crystals become integrated, and a granular structure is not formed. And, if the crystal orientation control layer 30 is too thick, the gaps between adjacent Ru crystals increase, but the proportion of the grain boundary layer in the granular magnetic layer 42 also increases, and the magnetic characteristics of the granular magnetic layer 42 readily decline. The optimum value for the thickness of the crystal orientation control layer 30 differs depending on whether the crystal orientation control layer 30 is formed from Ru alone or from a Ru alloy, and when a Ru alloy is used, depending on the composition thereof. In addition, the optimum value of the thickness of the crystal orientation control layer 30 varies with the grain diameters of the ferromagnetic crystal grains in the material used to form the granular magnetic layer 42, as well as the thickness of the nonmagnetic grain boundaries surrounding the ferromagnetic crystal grains. In general, it is desirable that the crystal orientation control layer 30 have a thickness of 5 nm or greater and 50 nm or less.

The granular magnetic layer 42 is a magnetic layer having a granular structure, comprising ferromagnetic crystal grains and porous or amorphous nonmagnetic grain boundaries surrounding the ferromagnetic crystal grains. The material comprised by the ferromagnetic crystal grains of the granular magnetic layer 42 comprises a CoCr system alloy. In particular, it is desirable that an alloy be used in which at least one element among Pt, Ni, Ta, and B be added to the Co and Cr, in order to obtain excellent magnetic characteristics and recording/reproduction characteristics. On the other hand, the material used to form the nonmagnetic grain boundaries in the granular magnetic layer 42 comprises an oxide of at least one element among Si, Al, Ti, Ta, Hf, and Zr. By using the above-described materials, a stable granular structure can be obtained.

It is desirable that the granular magnetic layer 42 have a film thickness of 5 nm or greater and 60 nm or less. By forming the film with a film thickness in this range, characteristics sufficient for use as a magnetic recording layer can be realized, and at the same time ease of magnetic recording and recording/reproduction resolution can be improved. Further, from the standpoint of improving productivity and raising recording densities, it is desirable that the granular magnetic layer 42 have a film thickness of 10 nm or greater and 30 nm or less.

The granular magnetic layer 42 comprises a plurality of magnetic portions 42-m in which recording and reproduction are performed, and a separation portion 42-s surrounding the magnetic portions 42-m. Here, the magnetic portions 42-m are portions having the magnetic characteristics of the as-deposited granular magnetic layer 42. On the other hand, the separation portion 42-s is magnetically altered by exposure to an activated halogen-containing gas, described below, and is a portion not having satisfactory magnetic characteristics, which magnetically separates the plurality of magnetic portions 42-m. When forming a discrete track medium, the plurality of magnetic portions 42-m form a plurality of concentric-shape tracks in recording track regions and servo patterns in regions for recording servo signals, and the separation portion 42-s forms regions demarcating the plurality of tracks and regions demarcating the servo patterns. In regions in which servo signals are recorded, signals are merely 0/1 signal reversals, and so a configuration may be employed in which the separation portion 42-s forms a servo pattern, and the magnetic portions 42-m form regions demarcating servo patterns. Or, when forming a patterned medium, the plurality of magnetic portions 42-m form a plurality of recording units (including recording units for recording servo signals), and the separation portion 42-s forms regions demarcating recording units. The placement intervals of the plurality of magnetic portions 42-m depend on the magnetic recording medium configuration and recording density. For example, the interval between adjacent tracks in discrete track medium with a recording density of 500 gigabits per square inch is 60 nm. And, the interval between adjacent recording units in a patterned medium with a recording density of 1 terabit per square inch is 25 nm.

In FIG. 1, an example is shown in which-the separation portion 42-s is formed over the entire thickness of the granular magnetic layer 42. However, the separation portion 42-s may be formed over only a portion in the thickness direction of the granular magnetic layer 42 (that is, a portion on the surface side of the granular magnetic layer 42), with the condition that the plurality of magnetic portions 42-m can be magnetically separated.

The separation portion 42-s is magnetically altered by exposure to activated halogen-containing reactive gas, described below, and the film thickness is not changed from the time of deposition. Hence no protrusions or depressions exist in the surface of the granular magnetic layer 42 even after formation of the magnetic portions 42-m and separation portion 42-s. Therefore, physical depressions and protrusions exerting adverse effects on the flying stability of a magnetic head are not formed either in the non-granular magnetic layer 44 or the protective layer 50 formed on top of the granular magnetic layer 42.

A non-granular magnetic layer 44, having a non-granular structure not comprising nonmagnetic grain boundaries of metal oxides or nitrides, is formed on the granular magnetic layer 42 in which are formed the magnetic portions 42-m and separation portion 42-s. It is desirable that the non-granular magnetic layer 44 be formed using an alloy in which, in addition to Co and Cr, at least one element from among Pt, Ni, Ta, and B is added. By using such a material, excellent magnetic characteristics and recording/reproduction characteristics can be obtained.

High durability of the magnetic recording medium is secured because the non-granular magnetic layer 44 blocks Co atoms eluted via the nonmagnetic grain boundaries of the granular magnetic layer 42. For this reason, the non-granular magnetic layer 44 must be a continuous film (a so-called full-coverage film) having a uniform film thickness. In order to achieve both high durability and high recording density for the magnetic recording medium, it is desirable that the non-granular magnetic layer have a film thickness of 1 nm or greater and 20 nm or less.

The protective layer 50 is a layer provided to protect the magnetic recording layer 40 and lower layers. The protective layer 50 can be formed using materials generally used in the prior art, such as materials mainly comprising carbon (for example, diamond-like carbon (DLC) or similar), ZrO₂, SiO₂, or similar. It is desirable that the protective layer 50 have a film thickness of 1 nm or greater and 10 nm or less. By forming the film with a thickness in this range, the occurrence of pinholes, declines in durability, and reduction of magnetic signal output due to broadening of the interval between the magnetic head and the magnetic recording layer 40 can be prevented.

Although not shown in FIG. 1, it is desirable that a liquid lubricant layer further be formed on the protective layer 50. A liquid lubricant layer can be formed using any material well-known in the prior art, such as perfluoro polyether lubricants. As for the liquid lubricant layer film thickness and other conditions, the conditions used in a normal magnetic recording medium can be employed.

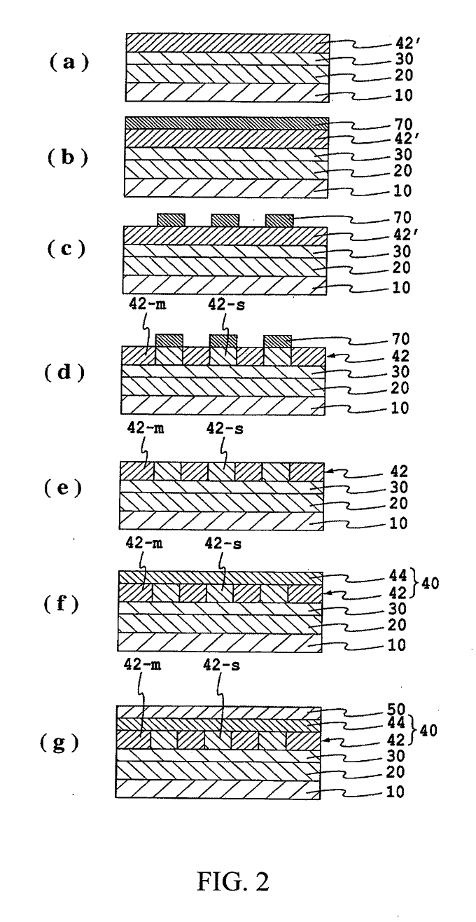

Next, a method of manufacture of a magnetic recording medium of this invention is explained, referring to FIG. 2. First, a soft magnetic layer 20 and a crystal orientation control layer 30 are deposited on a substrate 10. The soft magnetic layer 20 and the crystal orientation control layer 30 can be fabricated by any method known to practitioners of the art, such as sputtering, electroless plating, or similar.

Next, as shown in FIG. 2A, a granular magnetic layer 42′ is deposited on the crystal orientation control layer 30. In this Specification, the symbol 42′ represents a granular magnetic layer formed before forming the magnetic portions 42-m and separation portion 42-s. The granular magnetic layer 42′ can be fabricated by a sputtering method using a target comprising a mixture of the above-described ferromagnetic crystal grain material and a material forming nonmagnetic grain boundaries, or by electroless plating or another method known to practitioners of the art.

Next, as shown in FIG. 2B, a resist material is applied onto the granular magnetic layer 42′, to form a resist layer 70. The resist material used depends on the patterning method to be used. For example, when patterning using electron beam (EB) lithography, it is desirable that an EB lithography resist (for example, ZEP-520A manufactured by Zeon Corp. or similar) be used. The thickness of the resist layer 70 can be set arbitrarily, so long as the underlying granular magnetic layer 42′ can be protected from exposure to the activated halogen-containing reactive gas, described below.

Next, as shown in FIG. 2C, the resist layer 70 is patterned, and a portion of the granular layer 42′ is exposed. Patterning is performed, for example, by using EB lithography to harden a portion of the resist layer 70, then using a wet development method to remove unbridged portions. Or, a stamper having depressed portions where the resist layer 70 is to be left is pressed against the layer, to perform patterning of the resist layer 70 using the so-called nanoimprinting method.

Next, as shown in FIG. 2D, through exposure to activated halogen-containing reactive gas, the exposed portions of the granular magnetic layer 42′ are magnetically altered to become the separation portion 42-s, while the portions covered by the resist layer 70 become the magnetic portions 42-m. Halogen-containing reactive gases which can be used in this process include CF₄, CHF₃, CH₂F₂, C₃F₈, C₄F₈, SF₆, Cl₂, and similar gases containing halogens. It is sufficient that the pressure of the halogen-containing reactive gas in this process be within the range in which radical reactions proceed, and the pressure can for example be set in the range 0.1 to 3 Pa.

Activation of the halogen-containing reactive gas can for example be performed by means of a plasma generation mechanism used in reactive ion etching (RIE) or similar. The plasma generation mechanism used can be any mechanism known to practitioners of the art. In this invention, it is desirable that an inductive coupled plasma (ICP) method, which is capable of generating high-density plasma by a simple mechanism, be used. It is desirable that the power applied be set so as to be adequate to cause radical reaction of the halogen-containing reactive gas, and also be such that physical etching of the surface of the exposed granular magnetic layer 42′ not occur. While depending on the exposure time as well, in general it is preferable that power in the range 100 to 500 W, and more preferably 200 to 400 W, be applied to cause activation.

In this process, a bias power may be applied to the layered member comprising the granular magnetic layer 42′. However, it is desirable that the bias power be 0 W, in order that there be no physical etching of the surface of the exposed granular magnetic layer 42′.

Next, as shown in FIG. 2E, the resist layer 70 used as a mask in the preceding process is removed. The resist layer 70 can be removed by etching in oxygen plasma, or by cleaning using a commercially marketed resist stripping liquid.

When using a plurality of granular magnetic layers, processes from the above-described depositing of a granular magnetic layer to resist layer removal can be repeated. However, the processes from resist layer formation to resist layer removal are performed only for granular magnetic layers in which formation of magnetic portions 42-m and a separation portion 42-s is necessary, and are not performed for granular magnetic layers for which formation of magnetic portions 42-m and a separation portion 42-s is not necessary.

Next, as shown in FIG. 2F, a non-granular magnetic layer 44 is deposited on the granular magnetic layer 42, to obtain the magnetic recording layer 40. In forming the non-granular magnetic layer 44, similarly to formation of the granular magnetic layer 42, a sputtering method, an electroless plating method, or another method known to practitioners of the aft can be used. When forming the non-granular magnetic layer 44 using a sputtering method, a target not containing a material for formation of nonmagnetic grain boundaries is used.

Finally, as shown in FIG. 2G, a protective layer 50 is deposited on the non-granular magnetic layer 44, to obtain the magnetic recording medium. The protective layer 50 can be formed using a sputtering method, a chemical vapor deposition (CVD) method, or another method known to practitioners of the art. When forming a protective layer 50 comprising DLC, a CVD method, a physical vapor deposition (PVD) method, or another method can be used.

A liquid lubricant layer can be provided, as necessary, by using a dip-coating method, a spin-coating method, or another method known to practitioners of the art, to apply the above-described liquid lubricant material onto the protective layer 50.

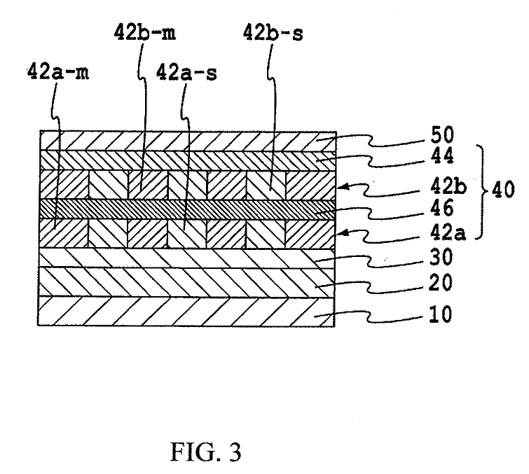

FIG. 3 shows another example of the configuration of a magnetic recording medium of this invention, comprising two granular magnetic layers. The magnetic recording medium of FIG. 3, similarly to the magnetic recording medium shown in FIG. 1, comprises a nonmagnetic substrate 10, soft magnetic layer 20, crystal orientation control layer 30, and protective layer 50. The magnetic recording layer 40 in the example of FIG. 3 has a layered structure comprising, in order, a first granular magnetic layer 42a, a coupling layer 46, a second granular magnetic layer 42b, and a non-granular magnetic layer 44. In FIG. 3, both the first granular magnetic layer 42a and the second granular magnetic layer 42b are examples of layers comprising a plurality of magnetic portions 42(a, b)-m, and separation portions 42(a, b)-s surrounding the magnetic portions 42-m.

In the configuration example of FIG. 3, the first granular magnetic layer 42a positioned between the crystal orientation control layer 30 and the coupling layer 46, and the second granular magnetic layer 42b positioned between the coupling layer 46 and the non-granular magnetic layer 44, can employ configurations similar to that of the granular magnetic layer 42 in the configuration example of FIG. 1.

However, a plurality of magnetic portions 42-m and a separation portion 42-s may be formed in only one among the first granular magnetic layer 42a and the second granular magnetic layer 42b, without forming magnetic portions 42-m or a separation layer 42-s in the other layer. As a condition enabling a sufficient signal-to-noise (S/N) ratio as magnetic signal characteristics of the magnetic recording medium, the granular magnetic layer 42(a, b) for formation of the plurality of magnetic portions 42-m and the separation portion 42-s can be decided. For example, when the first granular magnetic layer 42a has a higher coercivity than the second granular magnetic layer 42b, and moreover the separation portion 42a-s of the first granular magnetic layer 42a is rendered completely non-ferromagnetic, the first granular magnetic layer 42a alone can be made to comprise magnetic portions 42a-m and a separation portion 42a-s. Conversely, when the second granular magnetic layer 42b has a higher coercivity than the first granular magnetic layer 42a, and moreover the separation portion 42b-s of the second granular magnetic layer 42b is rendered completely non-ferromagnetic, the second granular magnetic layer 42b alone can be made to comprise magnetic portions 42b-m and a separation portion 42b-s. Further, when an adequate S/N cannot be secured with only one among the first granular magnetic layer 42a and the second granular magnetic layer 42b comprising magnetic portions 42-m and separation portions 42-s, both the first granular magnetic layer 42a and the second granular magnetic layer 42b can be made to comprise magnetic portions 42(a, b)-m and a separation portion 42(a, b)-s, as shown in FIG. 3.

In the configuration of FIG. 3, by adjusting the ferromagnetic anisotropic magnetic field and uniaxial anisotropy constants of the first granular magnetic layer 42a and second granular magnetic layer 42b as well as the thicknesses of these layers, and by adjusting the exchange coupling energy between the two granular magnetic layers 42 by means of the coupling layer 46, the ease of recording of the magnetic recording medium can be improved without detracting from thermal stability.

From the standpoint of appropriately adjusting the exchange coupling energy, it is desirable that the coupling layer 46 be formed using a metal selected from a group comprising V, Cr, Cu, Nb, Mo, Ru, Rh, Ta, W, Re, and Ir, or using an alloy the main component of which is one of the above. It is desirable that the thickness of the coupling layer 46 be 2 nm or less, and preferably 0.3 nm or less. By forming the coupling layer 46 with a thickness in this range, the exchange coupling energy between the two granular magnetic layers can be adjusted appropriately.

In the configuration example of FIG. 3, the non-granular magnetic layer 44 positioned between the second granular magnetic layer 42b and the protective layer 50 has a configuration similar to the non-granular magnetic layer 44 of the example of FIG. 1. The non-granular magnetic layer 44 of this configuration also blocks Co atoms eluted via the nonmagnetic grain boundaries of the two granular magnetic layers 42(a, b), and is effective for securing high durability for the magnetic recording medium.

Whether a separation portion 42-s is provided in either of, or both of, the first granular magnetic layer 42a and the second granular magnetic layer 42b, the separation portion 42-s is merely altered magnetically through exposure to activated halogen-containing reactive gas, and the thickness thereof is unchanged after deposition. Hence even after formation of magnetic portions 42(a, b)-m and a separation portion 42(a, b)-s, no depressions or protrusions exist on the surfaces of the granular magnetic layers 42(a, b). Therefore there is also no formation of physical depressions or protrusions in the surfaces of the coupling layer 46, non-granular magnetic layer 44, or protective layer 50, which are formed on the granular magnetic layers 42(a, b), which might adversely affect the flying stability of the magnetic head.

The layer configuration of the magnetic recording layer 40 in a magnetic recording medium of this invention is not limited to the configuration examples of FIG. 1 and FIG. 3. In magnetic recording medium of this invention, a magnetic recording layer may be used having any other configuration which satisfies the requirements that the magnetic recording layer comprise at least one granular magnetic layer having a granular structure, and a non-granular magnetic layer having a non-granular structure; that at least one of the granular magnetic layers comprise a plurality of magnetic portions and a separation portion surrounding the magnetic portions; that the separation portion have magnetic characteristics different from the magnetic characteristics of the magnetic portions; and that the non-granular magnetic layer be a continuous film.

### EMBODIMENTS

Below, embodiments of the invention are explained. These embodiments are merely examples used to explain the invention appropriately, and in no way limit the scope of the invention. Moreover, in these embodiments, a discrete track medium is described; but a patterned medium with a configuration of this invention can also be fabricated using the same processes.

### Embodiment 1

As the substrate 10, a chemically reinforced glass substrate with a flat surface (N-5 glass substrate, manufactured by Hoya Corp.) was prepared. A sputtering method was used to form a soft magnetic layer 20 of thickness 200 nm comprising CoZrNb, and a crystal orientation control layer 30 comprising an NiFeNb film of thickness 3 nm and a Ru film of thickness 14 nm, on the substrate 10. Next, a CoCrPt—SiO₂ target was used to sputter-deposit a granular magnetic layer 42′ of thickness 15 nm comprising CoCrPt—SiO₂ on the crystal orientation control layer 30, to obtain the layered member shown in FIG. 2A. Here, the nonmagnetic grain boundaries of the granular magnetic layer 42′ were formed from SiO₂.

Next, as shown in FIG. 2B, a spin-coating method was used to apply a resist material for EB lithography (ZEP-520A manufactured by Zeon Corp.) onto the granular magnetic layer 42′, to form a resist layer 70 of thickness 50 nm.

Next, an EB lithography device was used to expose the resist layer 70, and then EB resist developer liquid (ZEP-RD manufactured by Zeon Corp.) was used in a coater-developer device to perform development, to obtain a resist layer 70 having a desired pattern shape, as shown in FIG. 2C. EB lithography in data recording regions was performed so as to obtain a resist layer 70 with lines of width 40 nm, in the shape of concentric circles, arranged at intervals of 60 nm. On the other hand, EB lithography was also performed so as to leave the resist layer 70 at positions equivalent to burst islands in servo signal recording regions.

Next, the layered member with the resist layer 70 formed in a patterned shape was placed in an ICP high-density plasma etching device, and was exposed to activated halogen-containing reactive gas. As the halogen-containing reactive gas, CF₄ at a pressure of 1 Pa and flow rate of 50 sccm was used. As the plasma generation power, high-frequency power of 300 W at a frequency of 13.56 MHz was applied. No bias power was applied to the layered member at this time. In this processing, portions not covered by the resist layer 70 were magnetically altered, to form a separation portion 42-s. Portions covered by the resist layer 70 retained their initial magnetic characteristics to become magnetic portions 42-m, to obtain the granular magnetic layer 42 shown in FIG. 2D. Magnetic portions 42-m in data recording regions had a width of 40 nm, forming a plurality of tracks in concentric-circle shapes arranged at intervals of 60 nm.

Next, in the ICP high-density plasma etching device, high-frequency power of 200 W at a frequency of 13.56 MHz was applied to O₂ at a pressure of 1 Pa and flow rate of 50 sccm to perform etching using oxygen plasma, to remove the resist layer 70 as shown in FIG. 2E. No bias power was applied to the layered member at this time. Through the above processing, the resist layer 70 was removed while minimizing damage to the granular magnetic layer 42.

Next, as shown in FIG. 2F, a CoCrPt target was used in sputtering to form a non-granular magnetic layer 44 of thickness 10 nm, comprising a CoCrPt alloy, on the granular magnetic layer 42, to obtain the magnetic recording layer 40.

Next, as shown in FIG. 2G, a sputtering method was used to form a protective layer 50 of thickness 4 nm comprising carbon. Finally, a dip-coating method was used to apply perfluoro polyether, to form a liquid lubricant layer (not shown) of thickness 2 nm, to obtain the magnetic recording medium.

An AFM was used to evaluate physical depressions and protrusions in the magnetic recording medium obtained as described above. As a result, the maximum size of depressions and protrusions in the surface arising from the pattern of the magnetic portions 42-m and separation portion 42-s was 0.5 nm. These depressions and protrusions satisfied the criterion of 2 nm or less demanded of a magnetic recording medium from the standpoint of stability of head flight. In addition, head flight tests were performed using a commercially marketed perpendicular magnetic recording head. Contact of the head with the medium when using the magnetic recording medium obtained was approximately of the same extent as for a normal magnetic recording medium not exposed to an activated halogen-containing reactive gas. From this it was found that, despite the fact that a flattening process was not performed, a magnetic recording medium of this invention exhibited excellent head flight stability.

In addition, recording/reproduction characteristics of the magnetic recording medium obtained were evaluated. As a result, a difference between signal characteristics for tracks and signal characteristics for track gaps in data regions could be confirmed. Thus it was confirmed that adjacent tracks in the magnetic recording medium of this invention are magnetically separated.

### Embodiment 2

Three samples were fabricated by depositing a soft magnetic layer 20, crystal orientation layer 30, and granular magnetic layer 42′ on a substrate 10 as shown in FIG. 2A, using a procedure similar to that of Embodiment 1. The samples obtained were subjected to the processing described below, to verify the effect of exposure to activated halogen-containing reactive gas.

First, a non-granular magnetic layer 44, protective layer 50, and liquid lubricant layer were formed, without processing to form magnetic portions 42-m or a separation portion 42-s (that is, resist application, EB lithography, development, exposure to activated halogen-containing reactive gas, and resist removal), to obtain sample A. Sample A was a sample similar to an ordinary magnetic recording medium comprising continuous films.

Next, after applying a resist, exposure to activated halogen-containing reactive gas and resist removal were performed without performing EB exposure or development, and a non-granular magnetic layer 44, protective layer 50 and liquid lubricant layer were formed, to obtain sample B. Sample B was a sample similar to a magnetic recording medium having a magnetic recording layer comprising only magnetic portions 42-m.

Finally, after applying a resist, development, exposure to activated halogen-containing reactive gas, and resist removal were performed without performing EB exposure, and a non-granular magnetic layer 44, protective layer 50 and liquid lubricant layer were formed, to obtain sample C. Sample C was a sample similar to a magnetic recording medium having a magnetic recording layer comprising only a separation portion 42-s.

In fabricating the above samples, procedures similar to the procedures of Embodiment 1 were performed.

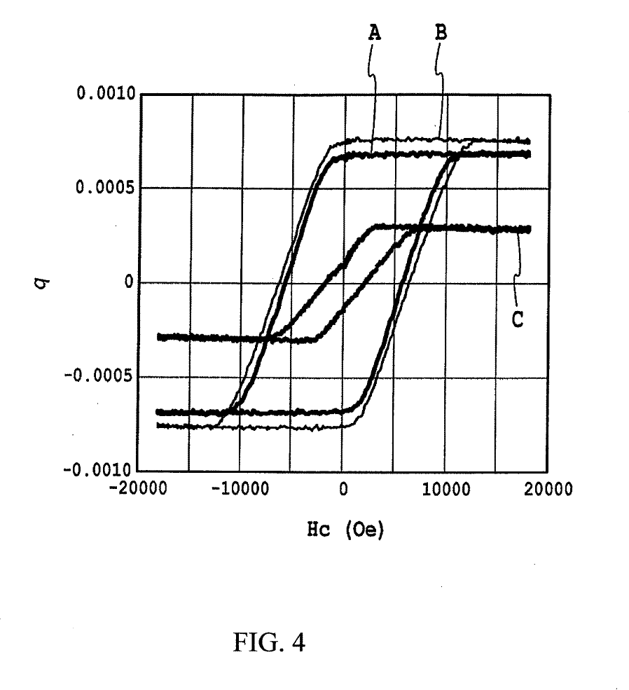

The samples A to C thus obtained were evaluated by magnetic Kerr effect measurements. The results appear in FIG. 4.

As is clear from FIG. 4, samples A and B have coercivities Hc of 5600 Oe and 6200 Oe respectively, and exhibit satisfactory ferromagnetic characteristics. On the other hand, sample C has an Hc of 2000 Oe or lower, and has been substantially altered magnetically. From this result it is seen that when a granular magnetic layer is exposed to activated halogen-containing reactive gas, even when a non-granular magnetic layer is deposited thereupon, the alteration in the granular magnetic layer cannot be compensated, and satisfactory characteristics are not exhibited. From this it is seen that the separation portion 42-s in a magnetic recording medium of this invention magnetically separates each of the plurality of magnetic portions 42-m.

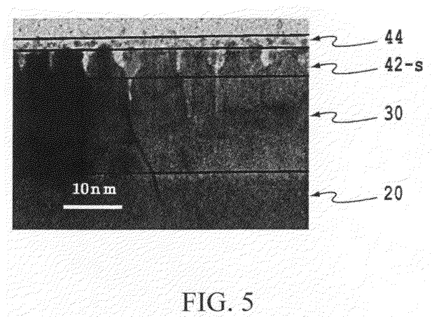

In addition, the cross-section of sample C was observed using a transmission electron microscope (TEM). A TEM photograph appears in FIG. 5. As is clear from FIG. 5, grooves, thought to be altered by exposure to the activated halogen-containing reactive gas, are observed in portions equivalent to the nonmagnetic grain boundaries of the granular structure (separation portion 42-s) in the granular magnetic layer. From this it is seen that alteration of the magnetic layer by the activated halogen-containing reactive gas spreads from nonmagnetic crystal grains, extending in the direction perpendicular to the surface of the magnetic recording medium. In other words, in exposure to activated halogen-containing reactive gas in a method of this invention, magnetic alteration having an anisotropy in the direction perpendicular to the surface of the magnetic recording medium occurs, in contrast with ion implantation and similar in which magnetic alteration occurs in random directions. This fact is advantageous for reducing the dimensions of the pattern of the magnetic portions 42-m and separation portion 42-s in the granular magnetic layer 42.

### Embodiment 3

In this embodiment, the magnetic recording medium is fabricated in which two granular magnetic layers are made adjacent with a coupling layer therebetween, and with magnetic portions and a separation portion formed in one of the granular magnetic layers.

A procedure similar to that of Embodiment 1 was used to form, on a substrate, a soft magnetic layer of thickness 200 nm comprising CoZrNb, and a crystal orientation control layer comprising NiFeNb film of thickness 3 nm and Ru film of thickness 14 nm. Next, sputtering using a CoCrPt—SiO₂ target was employed to deposit a first granular magnetic layer of thickness 10 nm, comprising CoCrPt—SiO₂, on the crystal orientation control layer.

Next, sputtering was used to deposit a coupling layer of thickness 0.5 nm, comprising Ru, on the first granular magnetic layer.

Next, sputtering using a CoCrPt—SiO₂ target was employed to deposit a second granular magnetic layer of thickness 5 nm, comprising CoCrPt—SiO₂, on the coupling layer.

A procedure similar to that of Embodiment 1 was used to subject the second granular magnetic layer thus obtained to resist application, EB exposure, development, exposure to activated halogen-containing reactive gas, and resist removal, to form magnetic portions and a separation portion in the second granular magnetic layer.

Finally, a procedure similar to that of Embodiment 1 was used to form a non-granular magnetic layer, protective layer, and liquid lubricant layer, to obtain a magnetic recording medium.

An AFM was used to evaluate physical depressions and protrusions in the magnetic recording medium obtained as described above. As a result, the maximum size of depressions and protrusions in the surface arising from the pattern of the magnetic portions and separation portion was 0.5 nm. These depressions and protrusions satisfied the criterion of 2 nm or less demanded of a magnetic recording medium from the standpoint of stability of head flight. In addition, head flight tests were performed using a commercially marketed perpendicular magnetic recording head. Contact of the head with the medium when using the magnetic recording medium obtained was approximately of the same extent as for a normal magnetic recording medium not exposed to an activated halogen-containing reactive gas. From this it was found that, despite the fact that a flattening process was not performed, a magnetic recording medium of this invention exhibited excellent head flight stability.

In addition, recording/reproduction characteristics of the magnetic recording medium obtained were evaluated. As a result, a difference between signal characteristics for tracks and signal characteristics for track gaps in data regions could be confirmed. Thus it was confirmed that adjacent tracks in a magnetic recording medium of this invention are magnetically separated.

It will be appreciated by those skilled in the art that the invention may be practiced otherwise than as disclosed herein without departing from the scope of the invention.

What is claimed is:

1. A magnetic recording medium, comprising:
a substrate; and
a soft magnetic layer, a crystal orientation control layer, a magnetic recording layer, and a protective layer formed sequentially on the substrate, wherein
the magnetic recording layer includes a granular magnetic layer having a granular structure and a non-granular magnetic layer having a non-granular structure, the granular magnetic layer including a plurality of magnetic portions and a separation portion surrounding the magnetic portions, the separation portion having magnetic characteristics different from magnetic characteristics of the magnetic portions, the non-granular magnetic layer being a continuous film.

2. The magnetic recording medium of claim 1, wherein the magnetic recording layer includes a plurality of granular magnetic layers and the non-granular magnetic layer.

3. The magnetic recording medium of claim 2, wherein
the plurality of granular magnetic layers include a first granular magnetic layer, a second granular magnetic layer, and a coupling layer of a nonmagnetic material provided between the first and second granular magnetic layers; and
the non-granular magnetic layer is provided on a side of the second granular magnetic layer opposite to the coupling layer.

4. A method of manufacturing a magnetic recording medium, comprising:
depositing a soft magnetic layer and a crystal orientation control layer sequentially on a substrate;
depositing a granular magnetic layer having a granular structure on the crystal orientation control layer;
processing the granular magnetic layer to form a plurality of magnetic portions and a separation portion; and
depositing a non-granular magnetic layer and a protective layer sequentially on the granular magnetic layer.

5. The method of claim 4, wherein the processing the granular magnetic layer further includes:
forming a mask having a plurality of openings on the granular magnetic layer;
exposing, through the mask, the granular magnetic layer to an activated halogen-containing reactive gas, thereby forming the separation portion in the granular magnetic layer at a position corresponding to the plurality of openings, and forming the magnetic portions at positions corresponding to portions of the mask that are not the openings; and
removing the mask.

6. The method of claim 4, wherein the depositing a granular magnetic layer includes depositing a plurality of granular magnetic layers on the crystal orientation control layer, and the processing the granular magnetic layer includes processing the plurality of granular magnetic layers.

7. The method of claim 4, wherein the separation portion has magnetic characteristics different from magnetic characteristics of the magnetic portions.

8. The method of claim 4, wherein the non-granular magnetic layer is a continuous film.
